(19) United States
(12) Patent Application Publication
(10) Pub. No.: US 2026/0120217 A1
(43) Pub. Date: Apr. 30, 2026

(54) TRUSTED DEVICE SECURE DATA TRANSFER BASED ON EMERGENCY CONDITION DETECTION

(71) Applicant: MOTOROLA MOBILITY LLC, WILMINGTON, DE (US)

(72) Inventors: AMIT KUMAR AGRAWAL, BANGALORE (IN); PANDURANGA REDDY PAILLA, NALGONDA (IN); VIJAYPRAKASH IDLUR, BANGALORE (IN)

(21) Appl. No.: 18/927,789

(22) Filed: Oct. 25, 2024

(51) Int. Cl. G06Q 50/26; H04L 9/40

(52) U.S. Cl. CPC G06Q 50/265; H04L 63/0428

(57) ABSTRACT

A method provides techniques for implementing secure data transfer to trusted devices based on detection of an emergency condition. A trusted device status is established for a second electronic device to which the electronic device can communicatively connect. First information is maintained in a secure location that requires entry of secure unlock information. An emergency condition associated with at least one of an established user of the electronic device and the electronic device, is detected or determined, based on trigger data received by the electronic device. In response to the emergency condition, the secure unlock information is automatically transmitted to the second electronic device.

### BACKGROUND

### 1. Technical Field

The present disclosure generally relates to electronic devices, and more specifically to security of electronic devices.

### 2. Description of the Related Art

Smartphones are often used to store a wide variety of important data, encompassing both personal and functional aspects of a user's life. Smartphones typically store contact information for various people, including phone numbers, email addresses, social media profiles, and other contact details of friends, family, and colleagues. As smartphones have become integral to daily activities, the types of data they store can often be highly sensitive. In some cases, the information can include names, addresses, dates of birth, and scanned copies of identification (ID) or documents. The expanded use of smartphones also coincides with and facilitates a transition from physical documents, such as driver licenses and insurance cards, to electronic versions stored on mobile phones, which is a significant step in the evolution of digital identity management. This shift from physical documents to electronic documents is driven by several factors, including convenience, enhanced security, and technological advancements. Governments, insurance companies, and individuals are increasingly embracing digital IDs and documents. As technology continues to evolve, the use of digital versions of important documents is expected to grow.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 depicts an example component makeup of an electronic device with specific components that enable the device to implement trusted device secure data transfer based on emergency condition detection, according to one or more embodiments;

FIG. 2 illustrates an example of an emergency transfer protocol (ETP) user interface presented to enable user de-activation of an emergency data sharing protocol following device detection/determination of a potential emergency condition, according to one or more embodiments;

FIG. 3 is an example emergency notification presented on a second electronic device, according to one or more embodiments;

FIG. 4 is an example of a user interface for trusted device configuration, according to one or more embodiments;

FIG. 5 is an example of a user interface for obtaining secure information, according to one or more embodiments

FIG. 6 depicts a flowchart of a computer-implemented method for secure data transfer to a trusted device based on detection of an emergency condition, according to one or more embodiments; and

FIG. 7 depicts a flowchart of a computer-implemented method for triggering transmission of secure unlock information in response to detecting an emergency condition, according to one or more embodiments.

### DETAILED DESCRIPTION

According to aspects of the present disclosure, an electronic device, a method, and a computer program product provide techniques for implementing trusted device secure data transfer based on detection of an emergency condition, according to one or more embodiments.

Emergency situations can occur suddenly and without warning, posing immediate threats to the safety and well-being of individuals. Critical emergencies can include accidents and medical emergencies that can potentially cause individuals to be left/rendered unconscious, critically injured, or even dead. In situations where the person is seriously injured and/or unconscious, and is admitted to medical facilities, family members may be prompted for insurance details, proof of identity, secure documents, and other relevant information, including power-of-attorney documents, wills, and/or other pertinent documents. Some or all of these documents may be stored on or accessible via the person's smart phone, which has multiple layers of security for accessing the device and/or to access a secure folder stored on the device. With these important personal documents being stored electronically on the person's smartphone, complete with the multiple layers of security for accessing the device, even family members can be barred from being able to access the documents required at this time crucial time of need.

The disclosed embodiments address the aforementioned issues by establishing one or more trusted electronic devices. Then, in response to detecting an emergency, secure information can be shared with at least one of the one or more trusted electronic devices.

According to one aspect, one or more trusted devices are initially established. One or more sensors are continuously or periodically monitored for trigger data indicative of an emergency condition. The sensors can include accelerometers, motion sensors, biometric sensors, among others. In response to detecting the trigger data that indicates a possible emergency condition, an emergency confirmation user interface is presented to a user. If there is no emergency, the user can cancel the pending emergency notification. In a situation where the user is incapacitated and does not cancel the pending emergency notification, an emergency notification is issued to one or more trusted devices. The emergency notification can include information regarding the emergency, as well as information to access secure data stored on the user's electronic device, and/or other storage locations, such as cloud storage devices. The secure data can include health insurance information, medical information, estate information, and/or other information that may be needed or useful to have as a result of an emergency such as a serious injury of the user.

In some embodiments, the shared information can be based on an emergency context. The emergency context can include a type of emergency, location of the emergency, time of day of the emergency, and so on. Upon detecting and/or determining an emergency condition, disclosed embodiments can transfer secure information to one or more of the previously established trusted electronic devices. The transferring of secure information can include providing secure information access, such as a secure link, one-time passcode, security question prompt and response, and the like. The providing of access can include transferring the secure information from the user's electronic device to one or more of the trusted electronic devices. The transferring of secure information can include transferring the secure information from a cloud storage location to one or more of the trusted electronic devices. One or more embodiments can include transferring secure unlock information that includes a one-time passcode, digital security key, digital certificate, and/or other information to enable access to data stored in a cloud storage account. The cloud storage account can then be accessed with the secure unlock information to retrieve the secure data via HTTP and/or other suitable techniques. Thus, embodiments can include transfer of secure information and/or secure unlock information that is required for accessing the secure information, in response to detecting an emergency condition. In this way, disclosed embodiments enable family members and/or other trusted individuals of a device user to obtain health, insurance, and other important information of/about a user in the event of a sudden emergency situation that requires access to securely maintained electronic documents, thereby helping to mitigate the chaos and confusion that can often accompany such events.

One or more embodiments can provide an electronic device that includes: a communications subsystem enabling the electronic device to communicatively connect to at least one second electronic device; a memory having stored thereon a trusted device secure data transfer (TDSDT) module; at least one processor coupled to the communications subsystem and the memory and which processes program code of the TDSDT module, the at least one processor configured to cause the electronic device to: establish a trusted device status for the second electronic device; maintain first information in a secure location that requires entry of secure unlock information; detect occurrence of an emergency condition associated with at least one of an established user of the electronic device and the electronic device itself, based on trigger data received by the at least one processor; and in response to the emergency condition, automatically transmit the secure unlock information to the second electronic device.

Some embodiments can provide a method that includes: establishing, on an electronic device, a trusted device status for a second electronic device to which the electronic device can communicatively connect; maintaining first information in a secure encrypted location that requires entry of secure unlock information; detecting an emergency condition associated with at least one of an established user of the electronic device and the electronic device, based on trigger data received by the electronic device; and in response to the emergency condition, automatically transmitting the secure unlock information to the second electronic device.

Further embodiments can provide a computer program product including: a non-transitory computer readable medium; and program code on the computer readable medium that when processed by a processor of an electronic device configures the processor to perform functions of the above-described method.

The above descriptions contain simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent in the following detailed description.

Each of the above and below described features and functions of the various different aspects, which are presented as operations performed by the processor(s) of the communication/electronic devices are also described as features and functions provided by a plurality of corresponding methods and computer program products, within the various different embodiments presented herein. In the embodiments presented as computer program products, the computer program product includes a non-transitory computer readable storage device having program instructions or code stored thereon, and configuring the electronic device and/or host electronic device to complete the functionality of a respective one of the above-described processes when the program instructions or code are processed by at least one processor of the corresponding electronic/communication device, such as is described above.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, “some embodiments”, or “one or more embodiments” are intended to indicate that a particular feature, structure, or characteristic described in connection with the embodiment is included in at least one implementation (embodiment) of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not for other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element (e.g., a person or a device) from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

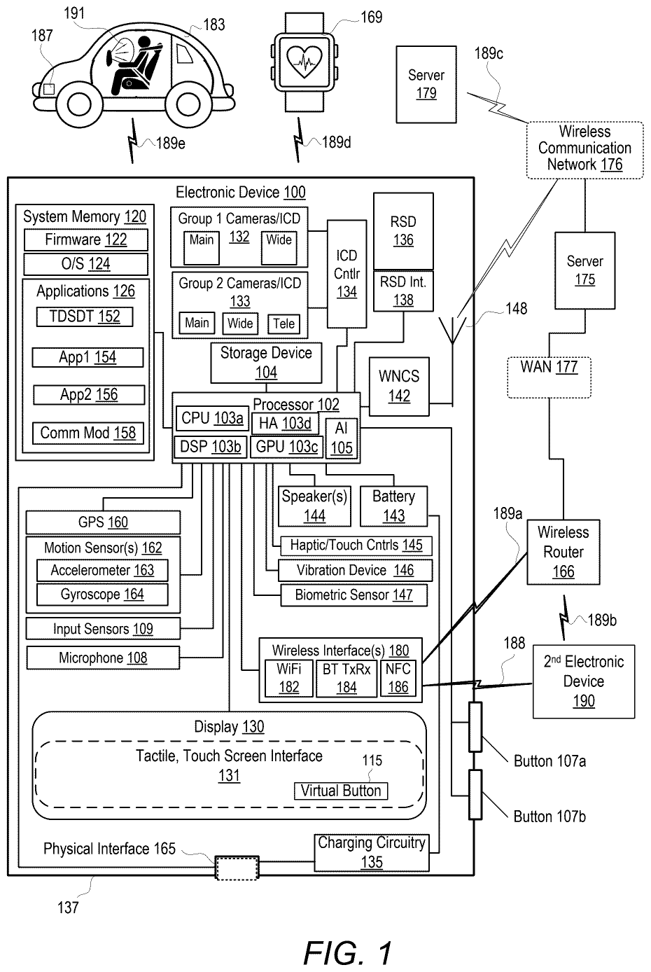

Those of ordinary skill in the art will appreciate that the hardware components and basic configuration depicted in the following figures may vary. For example, the illustrative components within electronic device 100 (FIG. 1) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure. Throughout this disclosure, the terms ‘electronic device’, ‘communication device’, and ‘electronic communication device’ may be used interchangeably, and may refer to devices such as smartphones, tablet computers, and/or other computing/communication devices.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

Referring now to the figures and beginning with FIG. 1, there is illustrated an example component makeup of electronic device 100, within which various aspects of the disclosure can be implemented, according to one or more embodiments. Examples of electronic device 100 include, but are not limited to, mobile devices, a notebook computer, a mobile phone, a smart phone, a digital camera with enhanced processing capabilities, a smart watch, a tablet computer, and other types of electronic device.

Electronic device 100 includes processor 102 (typically as a part of a processor integrated circuit (IC) chip), which includes processor resources such as central processing unit (CPU) 103a, communication signal processing resources such as digital signal processor (DSP) 103b, graphics processing unit (GPU) 103c, and hardware acceleration (HA) unit 103d. In some embodiments, the hardware acceleration (HA) unit 103d may establish direct memory access (DMA) sessions to route network traffic to various elements within electronic device 100 without direct involvement from processor 102 and/or operating system 124. Processor 102 can be and is interchangeably referred to as controller 102.

Processor 102 can, in some embodiments, include image signal processors (ISPs) (not shown) and dedicated artificial intelligence (AI) engines 105. In one or more embodiments, processor 102 can execute AI modules to provide AI functionality of AI engines 105. AI modules may include an artificial neural network, a decision tree, a support vector machine, Hidden Markov model, linear regression, logistic regression, Bayesian networks, and so forth. The AI modules can be individually trained to perform specific tasks and can be arranged in different sets of AI modules to generate different types of output. Processor 102 is communicatively coupled to storage device 104, system memory 120, input devices (introduced below), output devices, including integrated display 130, and image capture device (ICD) controller 134.

For simplicity in describing the features of the electronic device 100, the functionality provided by one or more of CPU 103a, DSP 103b, GPU 103c, and ICD controller 134 are collectively described as being performed by processor 102. Collectively, components integrated within processor 102 support computing, classifying, processing, transmitting and receiving of data and information, and presenting of graphical and photographic images within a display.

System memory 120 may be a combination of volatile and non-volatile memory, such as random-access memory (RAM) and read-only memory (ROM). System memory 120 can store program code or similar data associated with firmware 122, an operating system 124, and/or applications 126. During device operation, processor 102 processes program code of the various applications, modules, OS, and firmware, that are stored in system memory 120.

In accordance with one or more embodiments, applications 126 include, without limitation, trusted device secure data transfer (TDSDT) module 152, other applications, indicated as App1 154 and App2 156, and communication module 158. Each module and/or application provides program instructions/code that are processed by processor 102 to configures/cause processor 102 and/or other components of electronic device 100 to perform specific operations, as described herein. Descriptive names assigned to these modules add no functionality and are provided solely to identify the underlying features performed by processing the different modules. For example, trusted device secure data transfer (TDSDT) module 152 can include program instructions for implementing features of the disclosed embodiments. The TDSDT module 152 can include instructions that cause or configure processor 102 to identify an emergency condition (or determine that an emergency condition exists based on received/sensed data), and in response, transfer secure information or login and/or other credentials to access secure information from the electronic device 100 to a second electronic device, where the second electronic device is a trusted device. Other features are described in further detail throughout this disclosure.

ICD controller 134 can perform image acquisition functions in response to commands received from processor 102 in order to control group 1 ICDs 132 and group 2 ICDs 133 to capture video or still images of a local scene within a FOV of the operating/active ICD. In one or more embodiments, group 1 ICDs can be front-facing, and group 2 ICDs can be rear-facing, or vice versa. Throughout the disclosure, the term image capturing device (ICD) is utilized interchangeably to be synonymous with and/or refer to any one of the cameras 132, 133. Both sets of cameras 132, 133 include image sensors that can capture images that are within the field of view (FOV) of each respective camera 132, 133. In one or more embodiments, ICDs can be utilized to enable biometric authentication using facial image or iris scan recognition.

In one or more embodiments, electronic device 100 includes removable storage device (RSD) 136, which is inserted into RSD interface 138 that is communicatively coupled via system interlink to processor 102. In one or more embodiments, RSD 136 is a non-transitory computer program product or computer readable storage device encoded with program code and corresponding data, and RSD 136 can be interchangeably referred to as a non-transitory computer program product. RSD 136 may have a version of one or more applications, such as a copy of TDSDT module 152, stored thereon. Processor 102 can access RSD 136 to provision electronic device 100 with program code that, when executed/processed by processor 102, the program code causes or configures processor 102 and/or generally electronic device 100, to provide the various functions described herein.

Electronic device 100 includes an integrated display 130 which incorporates a tactile, touch screen interface 131 that can receive user tactile/touch input. As a touch screen device, integrated display 130 allows a user to provide input to or to control electronic device 100 by touching features within the user interface presented on integrated display 130. Tactile, touch screen interface 131 can be utilized as an input device. The touch screen interface 131 can include one or more virtual buttons, indicated generally as 115. In one or more embodiments, when a user applies a finger or stylus on the touch screen interface 131 in the region demarked by the virtual button 115, the touch of the region causes the processor 102 to execute code to implement a function associated with the virtual button. In some implementations, integrated display 130 is integrated into a front surface of electronic device 100 along with front ICDs, while the higher quality ICDs are located on a rear surface. Other embodiments provide for multiple integrated displays within electronic device 100 and references to integrated display 130 are assumed to refer to one or all of these multiple integrated displays.

Electronic device 100 can further include one or more input buttons, indicated as 107a and 107b, microphone 108, input sensors 109 (e.g., sensors enabling gesture detection by a user), and one or more output devices, such as speakers 144. While two buttons are shown in FIG. 1, other embodiments may have more or fewer input buttons. Input buttons 107a and 107b may provide controls for volume, power, and ICDs 132, 133. Microphone 108 can also be referred to as an audio input device. In some embodiments, microphone 108 may be used for identifying a user via voiceprint, voice recognition, and/or other suitable techniques.

Electronic device 100 further includes haptic touch controls 145, vibration device 146, fingerprint/biometric sensor 147, global positioning system (GPS) module 160, and motion sensor(s) 162. Vibration device 146 can cause electronic device 100 to vibrate or shake when activated. Vibration device 146 can be activated during an incoming call or message in order to provide an alert or notification to a user of electronic device 100. In one or more embodiments, integrated display 130, speakers 144, and vibration device 146 can generally and collectively be referred to as output devices.

Biometric sensor 147 can be used to read/receive biometric data, such as fingerprints, to identify or authenticate a user. In some embodiments, the biometric sensor 147 can supplement an ICD (camera), which provides facial recognition for user detection/identification.

GPS module 160 can provide time data and location data about the physical location of electronic device 100 using geospatial input received from GPS satellites. Motion sensor(s) 162 can include one or more accelerometers 163 and gyroscope 164. Motion sensor(s) 162 can detect movement of electronic device 100 and provide motion data to processor 102 indicating the spatial orientation and movement of electronic device 100. Accelerometers 163 measure linear acceleration of movement of electronic device 100 in multiple axes (X, Y and Z). Gyroscope 164 measures rotation or angular rotational velocity of electronic device 100. Electronic device 100 further includes a housing 137 (generally represented by the thick exterior rectangle) that contains/protects the components internal to electronic device 100.

Electronic device 100 also includes a physical interface 165. Physical interface 165 of electronic device 100 can serve as a data port and can be used as a power supply port that is coupled to charging circuitry 135 and device battery 143 to enable recharging of device battery 143 and/or powering of device.

Electronic device 100 further includes wireless network communication subsystem (WNCS) 142, which can represent one or more front end devices (not shown) that are each coupled to one or more antennas 148. In one or more embodiments, WNCS 142 can include a communication module with one or more baseband processors or digital signal processors, one or more modems, and a radio frequency (RF) front end having one or more transmitters and one or more receivers. Example communication module 158 within system memory 120 enables electronic device 100 to communicate with wireless communication network 176 and with other devices, such as server 175 and other connected devices, such as second electronic device 190 via one or more of data, audio, text, and video communications. Communication module 158 can support various communication sessions by electronic device 100, such as audio communication sessions, video communication sessions, text communication sessions, exchange of data, and/or a combined audio/text/video/data communication session.

WNCS 142 and antennas 148 allow electronic device 100 to communicate wirelessly with wireless communication network 176 via transmissions of communication signals to and from network communication devices, such as base stations or cellular nodes, of wireless communication network 176. Wireless communication network 176 further allows electronic device 100 to wirelessly communicate with server 175, and other communication devices, such as second electronic device 190, which can be similarly connected to wireless communication network 176. Second electronic device 190 can be a communication device, such as a smartphone.

In one or more embodiments, electronic device 100 can communicate wirelessly with external wireless devices, such as a WiFi router 166 or second electronic device 190, via one or more of short-range wireless interface(s) 180. In one or more embodiments, WiFi router 166 may be connected to a WAN 177 and/or server 175. Server 175 may also be connected to wireless communication network 176, which may enable connection to other servers, such as server 179 via communication signal 189c. In one or more embodiments, server 175, server 179, and/or other servers may be used to implement a cloud data store and/or cloud data server. Electronic device 100 can wirelessly communicate with second electronic device 190 via communication signal 188 (communicating between wireless interface(s) 180 and second electronic device 190). Communication signal 189a and communication signal 189b provide a communication path from electronic device 100 to second electronic device 190. In one or more embodiments, signals 188 and/or signals 189a may be transmitted by short range communication device(s) within wireless interface(s) 180. In one or more embodiments, a wearable computing device 169, such as a smartwatch, fitness tracker, or the like, may be paired with electronic device 100, and provide biometric data such as heart rate, breathing rate, and the like, to the electronic device 100. Communication signal 189d may be used to enable communication between electronic device 100 and wearable computing device 169. Wireless interface(s) 180 can include short-range wireless communication adapters/transceivers, such as wireless fidelity (Wi-Fi) transceiver 182 for Wi-Fi connectivity, Bluetooth transceiver 184, and near field communication (NFC) transceiver 186. In one or more embodiments, electronic device 100 can receive Internet or Wi-Fi based calls, text messages, multimedia messages, and other notifications via wireless interface(s) 180. In one or more embodiments, WNCS 142 with antenna(s) 148 and wireless interface(s) 180 collectively provide/represent the wireless communications subsystem of electronic device 100.

In one or more embodiments, electronic device 100 may communicate with an in-vehicle computer 187 of a vehicle 183. In one or more embodiments, the signal 189e may include a Bluetooth signal, or other near field communication signal to enable information regarding the vehicle 183 to be communicated from the in-vehicle computer 187 to the electronic device 100. The information can include event information, such as indicating deployment of an airbag 191, which can be indicative of a collision, and thus, a potential emergency condition. Electronic device 100 of FIG. 1 is only a specific example of a device that can be used to implement the embodiments of the present disclosure.

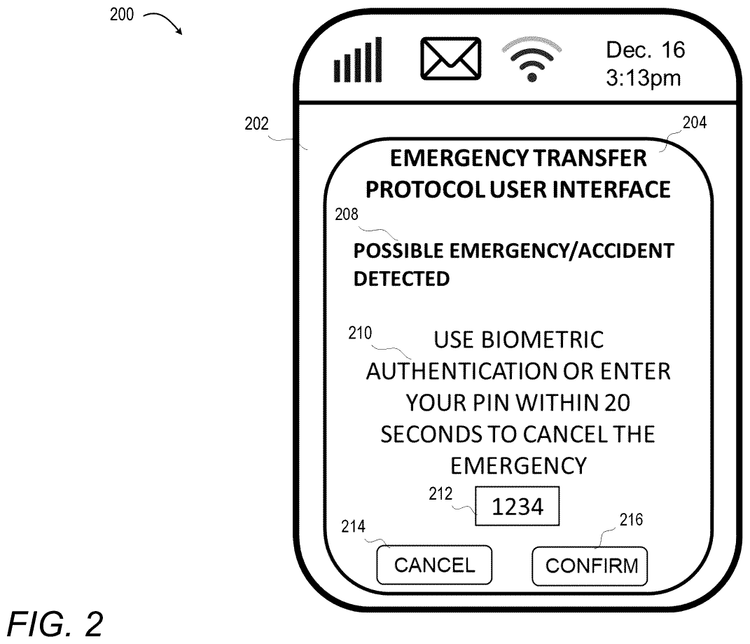

FIG. 2 illustrates an example of an emergency transfer protocol (ETP) user interface presented to enable user de-activation of an emergency data sharing protocol following device detection/determination of a potential emergency condition, according to one or more embodiments. Device 200 may be similar to electronic device 100 depicted in FIG. 1. Device 200 includes display 202. Emergency transfer protocol confirmation/de-activation (ETP) user interface 204 is rendered and presented on the display 202 of device 200 in response to trigger data that is determined by the device to correspond to an emergency condition. One or more embodiments of the disclosure can include a biometric sensor communicatively coupled to the at least one processor. To detect an emergency condition or to determine that an emergency condition exists, the at least one processor receives, from the biometric sensor, biometric data that is pre-established as trigger data corresponding to one emergency condition. As an example, for a person diagnosed with a heart condition, a heartbeat range can be specified, and a detected heartbeat rate outside of that range can be deemed to be trigger data corresponding to an emergency condition. As an example, a heartbeat range can be established as 60 beats per minute to 120 beats per minute. A heartbeat rate outside of that range can be interpreted as trigger data corresponding to an emergency condition. Similarly, a biometric sensor can detect an elevated heart rate that can be indicative of a medical condition such as tachycardia that may require immediate attention. An elevated heart rate can also be indicative of other conditions, such as anaphylaxis. Exposure to an allergen (food, insect bites, medications, etc.) can trigger an immune response, leading to anaphylaxis. An elevated heart rate can also be indicative of anxiety or a panic attack. The biometric sensor can be located within the electronic device (e.g., 147 of FIG. 1).

One or more embodiments can include an electronic device that includes a communications subsystem that enables the electronic device to communicatively connect to an external device that operates as a biometric sensor, and to detect an emergency condition, the at least one processor receives, via the communications subsystem, biometric trigger data correlated to an emergency condition affecting a registered user. In one or more embodiments, a user becomes a registered user upon successful login to one or more accounts on the electronic device. In one or more embodiments, the biometric sensor can be located in an external device (e.g., 169 of FIG. 1). Thus, embodiments can include a biometric sensor communicatively coupled to the at least one processor, and to detect an emergency condition, the at least one processor receives, from the biometric sensor, biometric data that is pre-established as trigger data corresponding to one emergency condition.

In one or more embodiments, the trigger data can be obtained from a sensor within the device 200, such as an accelerometer, motion sensor, microphone, and/or biometric sensor. One or more embodiments can include an accelerometer communicatively coupled to the at least one processor, where to detect an emergency condition, the at least one processor receives trigger data from the accelerometer that indicates an occurrence of an acceleration/deceleration incident affecting at least one of the electronic device and the established user and that is pre-established as one emergency condition. As an example, a sudden fall can cause an abrupt change in acceleration that is detectable by an accelerometer. Accordingly, an acceleration signal that indicates a fall has potential occurred can be used as trigger data corresponding to an emergency condition.

In one or more embodiments, the electronic device includes a communications subsystem that enables the electronic device to communicatively connect to an in-vehicle computer, and to detect an emergency condition, the at least one processor receives an accident indication from the in-vehicle computer via the communications subsystem. As an example, the in-vehicle computer 187 of FIG. 1 can communicate events to electronic device 100. The events can include a sudden deceleration event, an airbag deployment event, hard braking, rapid steering, and/or other relevant events. Thus, for example, in one or more embodiments, an airbag deployment event serves as trigger data corresponding to an emergency condition.

Upon receiving trigger data associated with an emergency, an ETP user interface 204 is rendered and presented. The confirmation user interface 204 includes a text field 208 that indicates a possible emergency/accident has been detected. However, as indicated in text field 210, the user is given an opportunity to cancel or confirm the emergency within a pre-set timeout period. Various scenarios can cause trigger data to be generated that may not be due to an accident or emergency. As an example, if a user drops his/her smartphone, it could produce trigger data synonymous with a fall event. Similarly, if a user is performing a physical activity, it can result in an elevated heart rate when no emergency exists. Accordingly, disclosed embodiments enable a user to cancel an emergency response caused by an emergency condition determination. In one or more embodiments, the electronic device 200 is configured with a pre-set timeout period, e.g., 20 seconds, as indicated in text field 210. The user can invoke the cancel button 214 to cancel the emergency response, and thus, cancel the transmission of secure unlock information to one or more second electronic devices. Alternatively, if there is an actual emergency, the user can invoke the confirm button 216 to initiate the transmission of secure unlock information to one or more second electronic devices. In one or more embodiments, authentication information, such as biometric authentication and/or non-biometric authentication (e.g., pin, passcode, or the like) entered in text entry field 212, are required in order to cancel an emergency. Thus, in some embodiments, biometric and/or non-biometric authentication is used to de-activate transfer of the secure unlock information.

One or more embodiments can include an electronic device including a processor configured to, in response to detecting the emergency condition: activate an emergency detected response protocol; generate and output a health check prompt on a display of the electronic device; monitor for receipt of a pre-established user biometric or security unlock code to de-activate transfer of the secure unlock information; withhold transmission of the secure unlock information in response to receiving the user biometric or the security unlock code within a pre-set timeout period; and trigger the transmission of the secure unlock information in response to not receiving entry of the user biometric or security unlock code within the pre-set timeout period. If no response is given within the pre-set timeout period, the emergency response is processed, which includes sending notifications to one or more of the a priori established trusted electronic devices. In one or more embodiments, in response to the user invoking the confirm button 216, the same emergency condition is processed, without needing to wait for the pre-set timeout period to elapse. The confirm button feature is useful for scenarios where a user is conscious, and is therefore able to signal that an emergency has occurred. One or more embodiments can include an electronic device that includes at least one processor, where the at least one processor is configured to cause the electronic device to: identify a type and severity of the emergency condition; and selectively transfer, to one of a second electronic device and an electronic storage accessible to the second electronic device, a specific subset of encrypted data from among a health insurance e-card, an identification e-card, and a will document, in addition to transferring corresponding secure unlock information to the second electronic device. The specific subset of encrypted data that is selected for transfer is selected in part based on the type and severity of the emergency condition.

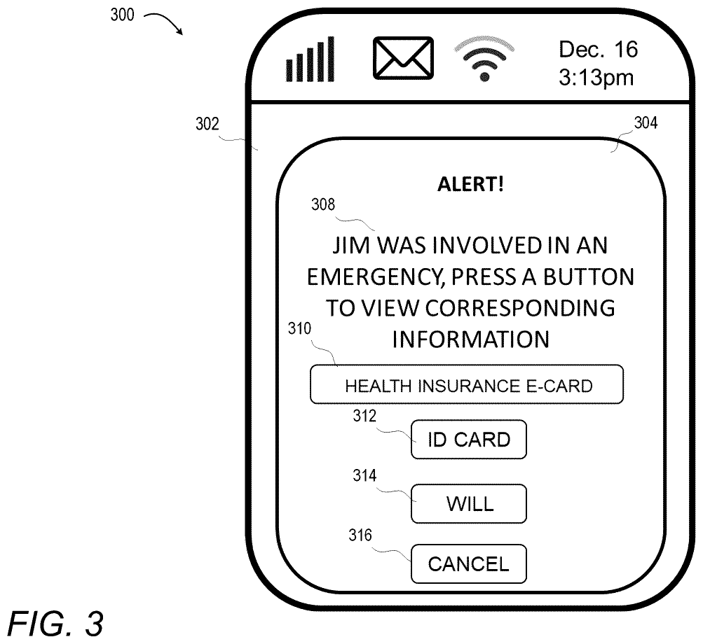

FIG. 3 is an example emergency notification user interface presented on a second electronic device, according to one or more embodiments. Device 300 may be similar to electronic device 100 depicted in FIG. 1. Device 300 includes display 302. Emergency notification user interface 304 is rendered and presented on the display 302 of device 300 in response to receipt of secure unlock information from a first electronic device of a user who is experiencing or involved in an emergency condition. Device 300 represents a trusted second electronic device. Emergency notification user interface 304 includes a text field 308 that indicates that a user of the first electronic device was involved in an emergency. The emergency notification user interface 304 can further include options to present one or more pieces of secure information based on the emergency. Option 310, when invoked, causes at least one processor of device 300 to render and present a health insurance e-card. Option 312, when invoked, causes at least one processor of device 300 to render and present an identification card for the user identified as being involved in an emergency (‘Jim’ in the example of FIG. 3). Option 314, when invoked, causes at least one processor of device 300 to render and present a will for the user identified as being involved in an emergency. Option 316, when invoked, causes at least one processor of device 300 to close the emergency notification user interface. Embodiments can include other important documents, such as a medical power of attorney, living will, financial documents, and/or other relevant information. In embodiments, the information made available on emergency notification user interface 304 may vary, based on the emergency type and/or severity. As an example, if the emergency condition is deemed to not be grave, then the will option 314 may be omitted. In one or more embodiments, if the user confirms the emergency (e.g., invokes the confirm button 216), then the emergency condition is deemed to not be grave. In one or more embodiments, if the user does not confirm the emergency, and an airbag deployment event is received, then the emergency condition is deemed to be grave, and the will option 314 is included. Other criteria may be used in one or more embodiments to determine which options are presented on emergency user interface 304.

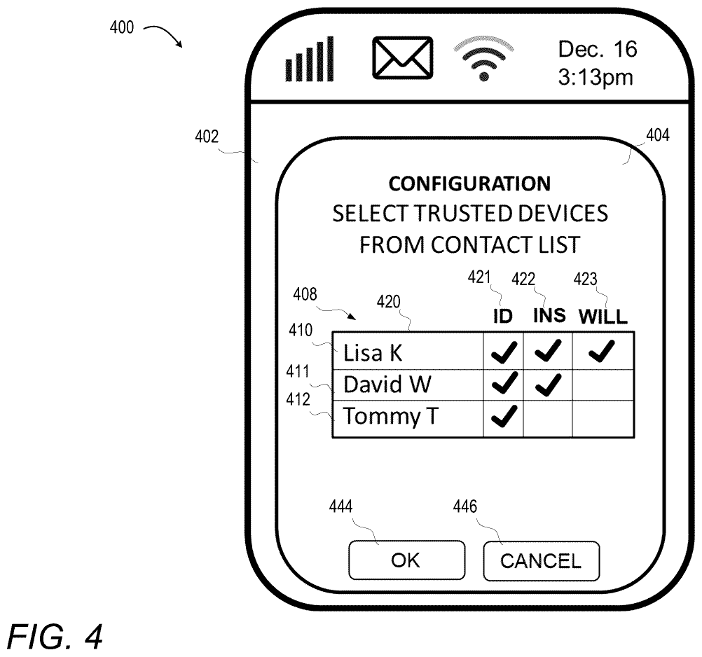

FIG. 4 is an example of a user interface for configuring trusted devices for emergency response transfer of secure unlock information, according to one or more embodiments. Device 400 may be similar to electronic device 100 depicted in FIG. 1. Device 400 includes display 402. Trusted device configuration user interface 404 is rendered and presented on the display 402 of device 400. The configuration of trusted electronic devices occurs as an initial process, prior to emergency condition detection, such that in the event that an emergency condition is later detected, the trusted electronic device(s) are already established. In one or more embodiments, the trusted electronic devices are identified and/or selected from a contact list stored on the electronic device 400. In one or more embodiments, a user selects one or more contacts from a contact database stored in electronic device 400, and electronic devices associated with the contacts are associated with device 400 as trusted electronic devices. Trusted device configuration user interface 404 can include an access permission table 408. In the example of FIG. 4, table 408 includes three rows, indicated as row 410, row 411, and row 412. Table 408 includes four columns, indicated as column 420, column 421, column 422, and column 423. Each row corresponds to a different trusted electronic device associated with the user indicated in column 420. In one or more embodiments, different access privileges can be established for each user. Column 421 indicates an access privilege to view identification card. Column 422 indicates an access privilege to view insurance information. Column 423 indicates an access privilege to view a will. In the example of FIG. 4, column 421 is selected (checkmark) for rows 410, 411, and 412, indicating that all of the trusted electronic devices are assigned access to view an identification card in the event of an emergency condition. Additionally, column 422 is selected for rows 410 and 411, indicating that the trusted electronic devices associated with the users indicated in row 410 and row 411 are assigned access to view insurance information in the event of an emergency condition, but the trusted electronic device associated with the user indicated in row 412 does not have access to view insurance information in the event of an emergency condition. Moreover, column 423 is selected for row 410, indicating that the trusted electronic device(s) associated with the user indicated in row 410 is assigned access to view a will in the event of an emergency condition, but the trusted electronic devices associated with the users indicated in row 411 and row 412 have not been assigned and therefore, do not have access to view the will in the event of an emergency condition. Thus, one or more embodiments can support transferring different types of data (or transferring credential information for secure access to different types of data) to different trusted electronic devices in response to detecting an emergency condition. Once the configuration is set by the user, the user can invoke the OK button 444 to cause the at least one processor of device 400 to save the trusted electronic device configuration to non-volatile memory within device 400. Invoking the cancel button 446 causes unsaved changes to the trusted electronic device configuration to be discarded.

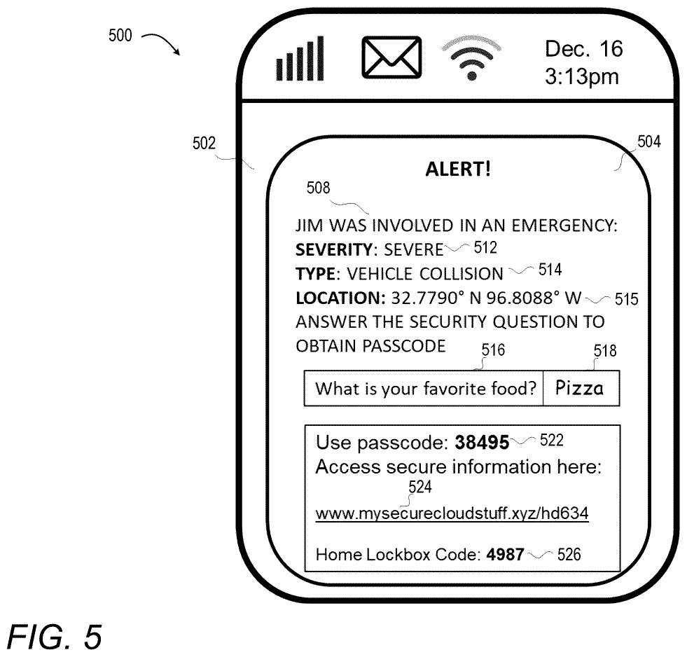

FIG. 5 is an example of a user interface for obtaining secure information, according to one or more embodiments. Device 500 may be similar to electronic device 100 depicted in FIG. 1. Device 500 includes display 502. Secure information access user interface 504 is rendered and presented on the display 502 of device 500. The secure information access user interface 504 can include a text field 508 identifying a user that was determined to be involved in an emergency. In one or more embodiments, the user interface 504 may further include text fields for a severity indication 512 for the emergency condition, and a type 514 for the emergency condition. In one or more embodiments, a severity may be determined, at least in part, based on a signal from an accelerometer. For example, a signal indicating a very abrupt deceleration may be indicative of a collision or other event that could subject a user to excessive forces, and accordingly, be categorized as a severe emergency. Similarly, a biometric sensor that indicates no detected breathing and/or heartbeat can also be categorized as a severe emergency. Conversely, an emergency that the user acknowledges (e.g., via button 216 of FIG. 2), along with biometric data that indicates breathing rate and heart rate in a healthy range, can be interpreted as a non-severe emergency. One or more embodiments may utilize additional criteria for determining emergency severity.

In one or more embodiments, a type 514 for an emergency condition may be detected and/or determined based on received trigger data. Trigger data received from an in-vehicle computer, such as an airbag deployment event can be used to determine the type of emergency condition as a vehicle collision. One or more embodiments can include identifying a type of emergency condition based on the trigger data, where the type of emergency condition includes one from a set comprising a fall, vehicle collision, vehicle rollover, and explosion, etc. Trigger data received from a biometric sensor that indicates no heart rate can be used to determine the type of emergency condition as cardiac arrest. One or more embodiments can include: receiving from a biometric sensor, biometric trigger data; evaluating the biometric trigger data to determine whether the biometric trigger data correlates to an emergency condition; and detecting the emergency condition, based on receiving the biometric trigger data correlated to an emergency condition. Trigger data received from a sensor that includes an abrupt deceleration that is absent of data from an in-vehicle computer can be used to determine the type of emergency condition as a fall. One or more embodiments may utilize additional criteria for determining a type of emergency condition. In one or more embodiments, the text field 508 may further include location information corresponding to the emergency condition 515. In one or more embodiments, the location information can include longitude and latitude coordinates obtained from a geolocation receiver within the electronic device (e.g., GPS module 160 of FIG. 1).

In one or more embodiments, the information that is made accessible on a trusted electronic device in response to detection of an emergency condition is stored in a secure filesystem within the electronic device of a user. The secure filesystem serves to provide strong protection for data at rest through encryption, access controls, and other security measures. It is designed to safeguard sensitive information such as cryptographic keys, personal data, and system configurations from unauthorized access, tampering, and data leakage. In one or more embodiments, files and data stored on the filesystem are encrypted using strong cryptographic algorithms (e.g., AES, RSA, and/or the like). The benefit of the secure filesystem is that the encryption used with the secure filesystem ensures that even if the physical storage medium is compromised (e.g., the device is lost or stolen), the data remains inaccessible without the appropriate decryption keys. A secure filesystem encrypts sensitive data, ensuring that only authorized entities can access it. The encryption is particularly important for devices handling personal, financial, or medical data as described in disclosed embodiments.

Transferring data from a secure filesystem to another device involves several critical steps to maintain the confidentiality and integrity of the data during the process. When an emergency condition is detected, data from the electronic device of the user that experienced the emergency condition can be exported from his/her electronic device as an encrypted backup file, which is then transferred to one or more of the designated trusted electronic devices. Each trusted electronic device that receives the data requires the necessary decryption keys or authentication credentials to access the data. One or more embodiments may utilize asymmetrical encryption with public/private key pairs as secure unlock information to enable decryption of the data by the trusted electronic devices. In one or more embodiments, these key pairs can be established and loaded to the respective devices as part of the trusted electronic device configuration depicted in FIG. 4. In this way, secure data within an electronic device can be transferred to a trusted electronic device upon detection and/or determination of an emergency condition.

In one or more embodiments, the encrypted data is shared with the trusted devices at the time of setting up the trusted electronic device configuration. However, the necessary decryption keys are not shared until an emergency condition is detected. In these embodiments, the encrypted data pertaining to identification, insurance information, and the like, resides on the trusted electronic device(s) in encrypted form. In response to detecting an emergency condition, only the keys need to be transmitted, which reduces the transmission time and network bandwidth requirements needed to enable access to the secure information during an emergency situation.

Secure information access user interface 504 may further include a security question 516 and prompt for a security question response 518. In some embodiments, a correct security question response is a criterion for providing secure unlock information. In some embodiments, the unlock information comprises at least one of a passcode and at least one security question with a corresponding security question response.

Secure information access user interface 504 may further include a one-time passcode (OTP) 522 for use when accessing a secure link 524. The secure link can point to a cloud storage system for retrieval of secure data and/or other secure unlock information. Referring again to FIG. 1, the submitting of keys, passcodes, and/or other secure unlock information from electronic device 100 to one or more servers, such as server 175 and/or 179, can enable retrieval of secure information such as medical information, insurance information, wills, power-of-attorney documents, financial documents, and the like. One or more embodiments can include transferring encrypted data to a cloud data store; and transferring access information for the cloud data store within the secure unlock information. Thus, in one or more embodiments, the secure data is transferred, in encrypted form, to a cloud storage system, while the secure unlock information is transferred to a trusted device. A user of the trusted device can then use the secure unlock information to access and decrypted the data stored in the cloud storage system. While described as concurrent operations, it is appreciated that the transfer and storage of the secure data is not necessarily temporal with the emergency condition, as embodiments permit the secure data to be transferred and stored at any time prior to the emergency condition and independent of the emergency condition. The combination of security questions, one-time passcodes, and encrypted filesystems can enable secure transfer of sensitive data to trusted electronic devices in response to detecting an emergency condition. In one or more embodiments, the secure unlock information may include PGP/GPG keys that have an expiration date established. In one or more embodiments, the expiration date of an existing key is edited in response to detecting an emergency condition. As an example, in response to detecting an emergency condition, a key may have an expiration date set to 10 days from the time of the emergency condition detection. Once the expiration date is set, the keys can then be shared with the trusted electronic device(s) via a secure key exchange technique such as elliptic curve cryptography. In this way, the trusted devices can view the secure information for a period of time, but cannot view it indefinitely, serving as an additional security measure to safeguard sensitive data. Since it is not known ahead of time when most emergency conditions occur, the aforementioned techniques enable the security of limited duration access while still accommodating the unpredictable nature of many emergency situations.

In one or more embodiments, the secure information access user interface 504 may further include a physical lockbox combination 526, instead of, or in addition to, encrypted electronically stored information. In this way, disclosed embodiments can also serve to provide access to physical documents, such as an original paper copy of a will, power of attorney, and/or other documents stored in a locked box with a combination lock. In one or more embodiments, a user can establish a physical lockbox combination when setting up the trusted devices, and in response to detecting an emergency condition, the physical lockbox combination can be shared with users associated with trusted electronic devices.

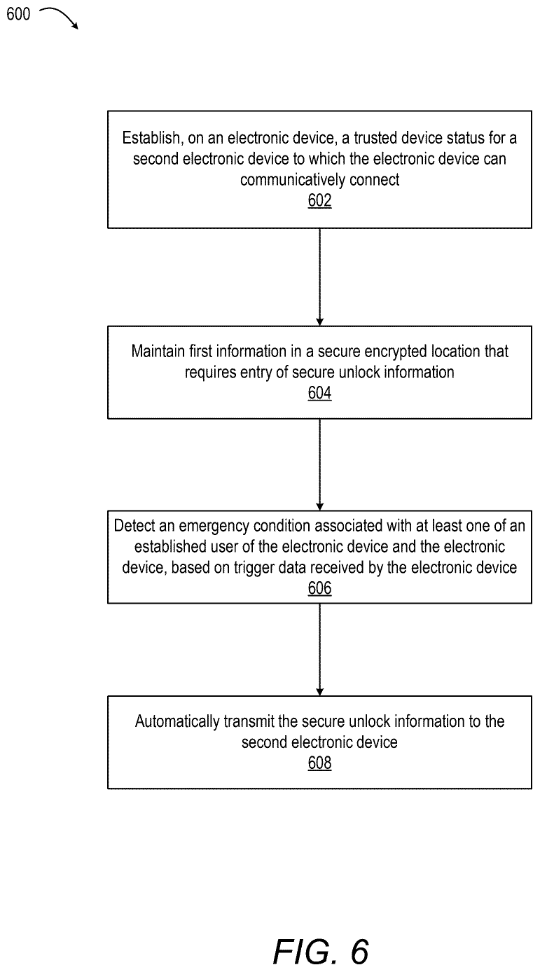

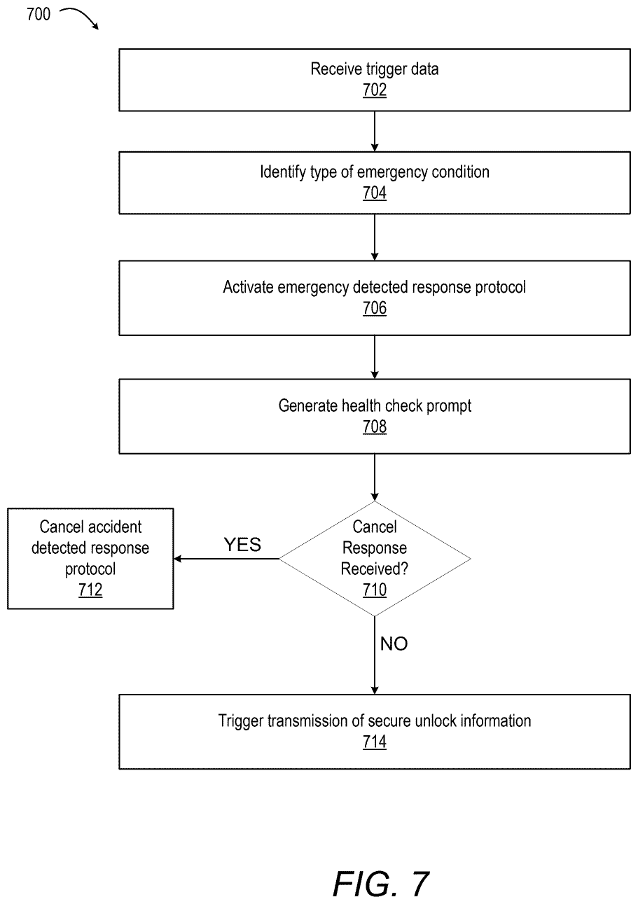

Referring now to the flowcharts presented by FIG. 6-FIG. 7, the descriptions of the methods in FIG. 6-FIG. 7 are provided with general reference to the specific components and features illustrated within the preceding FIGS. 1-5. Specific components referenced in the methods of FIG. 6-FIG. 7 may be identical or similar to components of the same name used in describing preceding FIGS. 1-5. In one or more embodiments, processor 102 (FIG. 1) configures electronic device 100 (FIG. 1) to provide the described functionality of the methods of FIG. 6 FIG. 7 by executing program code for one or more modules or applications provided within system memory 120 of electronic device 100, including trusted device secure data transfer (TDSDT) module 152.

FIG. 6 depicts a flowchart of a computer-implemented method for secure data transfer to a trusted device based on emergency condition detection, according to one or more embodiments. The method 600 starts at block 602, where a trusted device status is established, on an electronic device, for a second electronic device to which the electronic device can communicatively connect. In one or more embodiments, the establishment of trusted device status is performed using a user interface, such as shown in FIG. 4. The method 600 continues to block 604, where first information is maintained in a secure encrypted location that requires entry of secure unlock information. In one or more embodiments, the secure unlock information can include a one-time passcode and/or a correct security question response, such as depicted in FIG. 5. The method 600 continues to block 606, where an emergency condition associated with at least one of an established user of the electronic device and the electronic device is detected/determined, based on trigger data received by the electronic device. In one or more embodiments, the trigger data can include in-vehicle data such as sudden decelerations, airbag deployments, hard braking, and the like. In one or more embodiments, the trigger data can include biometric data such as breathing rate, heart rate, and the like. In one or more embodiments, the trigger data can include environmental data, such as temperature data, location data, audio data, such as gunshot detection, explosions, and/or other noises, and/or other data. One or more sets of trigger data may be combined to determine if an emergency condition is likely to exist, as well as a type and/or severity of the emergency condition. The method 600 continues to block 608, where the secure unlock information is automatically transmitted to the second electronic device that is pre-established as a trusted electronic device. The secure unlock information can include one-time passcodes, security questions/responses, biometric authentication, exchange of keys, and/or other suitable secure unlock information. In one or more embodiments, the secure unlock information may be time limited, and have an expiration date, such that after the expiration date, the secure information can no longer be accessed on the trusted electronic device. In one or more embodiments, the secure unlock information can include the electronic document or files that is protected by the access credential communicated within the secure unlock information.

FIG. 7 depicts a flowchart of a computer-implemented method for triggering transmission of secure unlock information in response to detecting an emergency condition, according to one or more embodiments. The method 700 starts at block 702, where trigger data is received. The trigger data can originate from sensors within the electronic device. The trigger data can originate from an external device, such as a wearable computing device (e.g., smartwatch, fitness tracker, or the like). The trigger data can originate from an in-vehicle computer. In one or more embodiments, an electronic device (e.g., device 100 of FIG. 1) may be paired (e.g., via Bluetooth) with an in-vehicle computer, such that data can be transferred to and from the electronic device and the in-vehicle computer. Trigger data such as airbag deployment events, hard braking, sudden steering movements, excessive speed, and/or other criteria can be used, at least in part, for detecting and/or determining an emergency condition, in one or more embodiments. The method 700 continues to block 704, where a type of emergency condition is identified. The type of emergency can be identified based on the type of trigger data received. As examples, trigger data received from an in-vehicle computer, such as an airbag deployment event can be used to determine the type of emergency condition as a vehicle collision. Trigger data received from a biometric sensor that indicates no heart rate can be used to determine the type of emergency condition as cardiac arrest. Trigger data received from a movement/acceleration sensor that includes an abrupt deceleration that is absent of data from an in-vehicle computer can be used to determine the type of emergency condition as a fall. The method 700 then continues to block 706 where an emergency detected response protocol is activated. The emergency detected response protocol can include issuing alerts and/or prompts to one or more electronic devices, as well as transferring secure unlock information, initiating security prompts, and so on. The method 700 then continues to block 708 where a health check prompt is generated. The health check prompt serves to confirm that the emergency condition is real and provides an opportunity for a user to cancel an emergency response caused by an emergency condition detection/determination. An example of user interface that includes a health check prompt is shown in FIG. 2. The method 700 then continues to block 710, where a check is made to determine if a response is received. If, at block 710, a cancel response is received (e.g., invoking button 214 in FIG. 2), then the method 700 continues to block 712, where the emergency detected response protocol is canceled, and no secure unlock information is transferred to trusted electronic devices. If, at block 710, a positive confirmation is received (e.g., invoking button 216 in FIG. 2), or if no response is received after a pre-set timeout period, then the method 700 continues to block 714, where the transmission of secure unlock information is triggered.

As can now be appreciated, disclosed embodiments provide techniques for sharing secure data with trusted electronic devices in response to a user device detecting an emergency condition or determining that an emergency condition has occurred based on evaluating received trigger data. Thus, disclosed embodiments can provide important health, medical, legal, financial, and other information to family members and/or others who are deemed trustworthy or responsible in a time of crisis, thereby serving to assist in coping with a stressful situation such as an emergency or accident. The health, medical, legal, financial, and other information provided by the disclosed embodiments can help streamline admission into hospitals, thereby expediting the administering of medical care, potentially reducing the risks of protracted recovery or even death.

In the above-described methods, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined primarily by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals, but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. An electronic device comprising:
a communications subsystem enabling the electronic device to communicatively connect to at least one second electronic device;
a memory having stored thereon a trusted device secure data transfer (TDSDT) module;
at least one processor coupled to the communications subsystem and the memory and which processes program code of the TDSDT module, the at least one processor configured to cause the electronic device to:
establish a trusted device status for the second electronic device based on user selection of the second electronic device from a contact list stored on the electronic device;
maintain first information in a secure encrypted location that requires entry of a secure unlock information;
detect an emergency condition associated with at least one of an established user of the electronic device and the electronic device, based on trigger data received by the at least one processor; and
in response to the emergency condition, automatically transmit the secure unlock information to the second electronic device.

2. The electronic device of claim 1, further comprising: an accelerometer communicatively coupled to the at least one processor, wherein to detect an emergency condition, the at least one processor receives trigger data from the accelerometer that indicates an occurrence of an acceleration/deceleration incident affecting at least one of the electronic device and the established user that is pre-established as one emergency condition.

3. The electronic device of claim 1, wherein the communications subsystem enables the electronic device to communicatively connect to an external device that operates as a biometric sensor, and to detect an emergency condition, the at least one processor receives, via the communications subsystem, biometric trigger data correlated to an emergency condition affecting a registered user.

4. The electronic device of claim 1, further comprising a biometric sensor communicatively coupled to the at least one processor, and to detect an emergency condition, the at least one processor receives, from the biometric sensor, biometric data that is pre-established as trigger data corresponding to one emergency condition.

5. The electronic device of claim 1, wherein the communications subsystem enables the electronic device to communicatively connect to an in-vehicle computer, and to detect an emergency condition, the at least one processor receives an accident indication from the in-vehicle computer via the communications subsystem.

6. The electronic device of claim 5, wherein the at least one processor is configured to cause the electronic device to, in response to detecting the emergency condition:
activate an emergency detected response protocol;
generate and output a health check prompt on a display of the electronic device;
monitor for receipt of a pre-established user biometric or security unlock code to de-activate transfer of the secure unlock information;
withhold transmission of the secure unlock information in response to receiving the user biometric or the security unlock code within a pre-set timeout period; and
trigger the transmission of the secure unlock information in response to not receiving entry of the user biometric or security unlock code within the pre-set timeout period.

7. The electronic device of claim 1, wherein:
the at least one processor is configured to cause the electronic device to transfer encrypted data to a cloud data store; and
the at least one processor transfers access information for the cloud data store within the secure unlock information.

8. The electronic device of claim 1, wherein the at least one processor is configured to cause the electronic device to:
identify a type and severity of the emergency condition; and
selectively transfer, to one of a second electronic device and an electronic storage accessible to the second electronic device, a specific subset of encrypted data from among a health insurance e-card, an identification e-card, and a will document, in addition to transferring corresponding secure unlock information to the second electronic device, the specific subset of encrypted data selected in part based on the type and severity of the emergency condition.

9. The electronic device of claim 1, wherein the unlock information comprises at least one of a passcode and at least one security question with a corresponding security question response.

10. A method comprising:
establishing, on an electronic device, a trusted device status for a second electronic device to which the electronic device can communicatively connect, wherein the establishing is based on user selection of the second electronic device from a contact list stored on the electronic device;
maintaining first information in a secure encrypted location that requires entry of secure unlock information;
detecting an emergency condition associated with at least one of an established user of the electronic device and the electronic device, based on trigger data received by the electronic device;
and in response to the emergency condition, automatically transmitting the secure unlock information to the second electronic device.

11. The method of claim 10, wherein the electronic device further comprises an accelerometer, and the method further comprises receiving trigger data from the accelerometer that indicates an occurrence of an acceleration/deceleration incident affecting at least one of the electronic device and the established user that is pre-established as one emergency condition.

12. The method of claim 11, further comprising identifying a type of emergency condition based on the trigger data, wherein the type of emergency condition includes one from a set comprising a fall, vehicle collision, vehicle rollover, and explosion.

13. The method of claim 10, further comprising:
connecting, via a communications subsystem, the electronic device to an external device that operates as a biometric sensor;
receiving, via the communications subsystem, from the external device, biometric trigger data correlated to an emergency condition; and
detecting the emergency condition, based on receiving the biometric trigger data.

14. The method of claim 10, further comprising:
receiving from a biometric sensor, biometric trigger data;
evaluating the biometric trigger data to determine whether the biometric trigger data correlates to an emergency condition; and
detecting the emergency condition, based on receiving the biometric trigger data correlated to an emergency condition.

15. The method of claim 10, further comprising:
in response to detecting the emergency condition:
activating an emergency detected response protocol;
generating and outputting a health check prompt on a display of the electronic device;
monitoring for receipt of a pre-established user biometric or security unlock code to de-activate transfer of the secure unlock information;
withholding transmission of the secure unlock information in response to receiving the user biometric or the security unlock code within a pre-set timeout period; and
triggering the transmission of the secure unlock information in response to not receiving entry of the user biometric or security unlock code within the pre-set timeout period.

16. The method of claim 10, further comprising:
transferring encrypted data to a cloud data store; and
transferring access information for the cloud data store within the secure unlock information.

17. The method of claim 10, further comprising:
identifying a type and severity of emergency condition; and
selectively transferring, to one of a second electronic device and an electronic storage accessible to the second electronic device, a specific subset of encrypted data from among a health insurance e-card, an identification e-card, and a will document, in addition to transferring corresponding secure unlock information to the second electronic device, the specific subset of encrypted data selected in part based on the type and severity of the emergency condition.

18. The method of claim 17, wherein transferring access information includes transferring at least one of a passcode and at least one security question with a corresponding security question response.

19. A computer program product comprising a non-transitory computer readable medium having program instructions that when executed by a processor of an electronic device, configure the electronic device to perform functions comprising:
establishing, with at least one second electronic device, a trusted device status for the second electronic device, wherein the establishing is based on user selection of the second electronic device from a contact list stored on the electronic device;
maintaining first information in a secure encrypted location that requires entry of a secure unlock information;
detecting an emergency condition associated with at least one of an established user of the electronic device and the electronic device, based on trigger data received by the electronic device; and
in response to the emergency condition, automatically transmitting the secure unlock information to the second electronic device.

20. The computer program product of claim 19, further comprising program instructions for:
in response to detecting an emergency condition:
activating an emergency detected response protocol;
generating and outputting a health check prompt on a display of the electronic device;
monitoring for receipt of a pre-established user biometric or security unlock code to de-activate transfer of the secure unlock information;
withholding transmission of the secure unlock information in response to receiving the user biometric or the security unlock code within a pre-set timeout period; and
triggering the transmission of the secure unlock information in response to not receiving entry of the user biometric or security unlock code within the pre-set timeout period.
